(19) United States
(12) Patent Application Publication
(10) Pub. No.: US 2026/0012820 A1
(43) Pub. Date: Jan. 8, 2026

(54) SYSTEM AND METHOD FOR DETERMINING AN OPERATIVE STATUS OF A BASE GRID FOR NETWORK ANALYSIS

(71) Applicant: JIO PLATFORMS LIMITED, Ahmedabad (IN)

(72) Inventors: Aayush BHATNAGAR, Navi Mumbai (IN); Hanumant KADAM, Mumbai (IN); Vikas WADHWANI, Indore (IN); Manoj SHETTY, Bhundani (IN); Roshni SONI, Indore (IN); Dharmesh A. CHITALIYA, Dombivali (E), Thane (IN); Sneha VIRKAR, Mumbai (IN); Neelabh KRISHNA, Gumgram (IN); Pradeep Kumar BHATNAGAR, Navi Mumbai (IN)

(73) Assignee: JIO PLATFORMS LIMITED, Ahmedabad (IN)

(21) Appl. No.: 18/992,325

(22) PCT Filed: May 15, 2024
(86) PCT No.: PCT/IN2024/050560

§ 371 Date: Jan. 8, 2025

(30) Foreign Application Priority Data
Jun. 27, 2023 (IN) 202321043154

(51) Int. Cl. H04W 24/08; H04L 41/22; H04W 4/021

(52) U.S. Cl. CPC H04W 24/08; H04L 41/22; H04W 4/021

(57) ABSTRACT

The present disclosure provides a system (108) and a method (300) for base grid creation for analyzing geographical locations The system (108) generates a base grid where an aggregation of data, specifically on international mobile subscriber identity (IMSI) levels provides a real time health status of each IMSI within the base grid. The system (108) generates IMSI level identification and plotting where a real time issue with a specific user may be identified. The system (108) summarizes data at different levels of aggregation and reduces a number of data points to be processed and displayed. The system (108) improves performance and scalability, allowing users to analyze and visualize large volumes of data efficiently.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for grid creation in a wireless telecommunications network. More particularly, the present disclosure relates to a system and a method for determining an operative status of a base grid for network analysis and analyzing geographical locations.

### Definition

As used in the present disclosure, the following terms are generally intended to have the meaning as set forth below, except to the extent that the context in which they are used to indicate otherwise.

The expression ‘base grid (degree grid, a coordinate grid or a latitude-longitude grid)’, used hereinafter in the specification refers to a system of lines used to define and locate positions on the Earth's surface based on latitude and longitude coordinates. The base grid is a reference framework that divides the Earth's surface into a grid of horizontal lines (latitude) and vertical lines (longitude) to establish precise locations. The base grid is a fundamental concept in network design and refers to the underlying structure used to organize and connect network devices. The base grid typically consists of a collection of horizontal and vertical lines or segments, often arranged in a grid-like pattern, on which various network elements such as routers, switches, and access points are placed. The purpose of the base grid is to provide a scalable and organized way to connect network devices and to facilitate efficient traffic flow.

The expression ‘International Mobile Subscriber Identity (IMSI)’, used hereinafter in the specification refers to a unique 15-digit number that identifies every user in a Global System for Mobile communication (GSM) and Universal Mobile Telecommunication system (UMTS) network.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Traditional network planning often relies on static assumptions about network usage patterns and traffic demands. Further, traditional network planning may assume predictable traffic volumes and fixed user behaviour, which may limit the ability to accurately anticipate and respond to dynamic changes in network requirements. Traditional network planning methods may rely on historical data or limited periodic measurements, which may not reflect real-time network conditions. This may result in suboptimal network designs that do not effectively address current or future demands. Traditional network planning may be rigid and less adaptable to changing requirements or unforeseen events. Traditional network planning is challenging to modify or expand the network infrastructure once implemented, leading to potential inefficiencies and difficulties in scaling the network to accommodate growth or evolving technologies. Traditional network planning methods use coarse-grained spatial models, assuming uniform network conditions across larger geographic areas. This approach overlooked localized variations in demand, coverage, or capacity requirements, resulting in suboptimal network designs at a more granular level.

Further, traditional network planning methods are not fully considering the potential of emerging technologies and their impact on network requirements. This may limit the ability to leverage innovative solutions or optimize network designs to take advantage of advancements such as virtualization, cloud computing, or software-defined networking. Traditional network planning methods may involve limited stakeholder engagement, excluding valuable insights and perspectives from end-users, service providers, or other relevant parties. This may lead to network designs that do not align with user needs or fail to consider specific requirements of different stakeholders. Traditional network planning methods may not incorporate dynamic optimization techniques that continuously monitor and adjust network configurations based on real-time conditions. This may result in sub-optimal utilization of network resources and inefficient allocation of capacity.

There is, therefore, a need in the art to provide a system and a method that can mitigate the problems associated with the prior arts.

### Objects of the Invention

It is an object of the present disclosure to provide a system and a method that is configured to perform accurate coverage analysis by overlaying network coverage data and aid in identifying coverage gaps, dead zones, and areas with weak signal strength, enabling network planners to optimize coverage and improve service quality.

It is an object of the present disclosure to provide a system and a method that helps in assessing network capacity requirements by analyzing population density, traffic patterns, and user demands at different geographic locations.

It is an object of the present disclosure to provide a system and a method that assists in site selection for network infrastructure deployment and help in identifying suitable locations that maximize coverage, minimize interference, and comply with regulatory requirements.

It is an object of the present disclosure to provide a system and a method that aids in optimizing network performance by analyzing network parameters like signal strength, signal interference, and handover patterns in different geographic areas.

It is an object of the present disclosure to provide a system and a method that assists in strategic network expansion planning by identifying underserved or unserved areas where network coverage can be extended to reach a larger customer base.

It is an object of the present disclosure to provide a system and a method that enables real-time network monitoring by integrating network performance data with geographic information. I

It is an object of the present disclosure to provide a system and a method that helps in visualizing network metrics on maps, identifying areas experiencing service disruptions, and facilitate proactive troubleshooting and maintenance.

### SUMMARY

The present disclosure discloses a system for determining an operative status of a base grid for network analysis. The system includes a server and a processing unit. The server is configured to store a plurality of data samples received from a plurality of user equipments residing in a geographic area defined by a plurality of base grids. The processing unit is configured to cooperate with the server to receive the plurality of data samples. The processing unit is further configured to group the plurality of data samples into one or more groups based on at least one of an international mobile subscriber identity (IMSI) level and a map level. The processing unit is further configured to aggregate the plurality of grouped data samples of each group corresponding to each radio-frequency (RF) parameter of a set of RF parameters to determine a plurality of key performance indicators (KPIs) corresponding to each base grid. The processing unit is further configured to display the determined plurality of KPIs representing the operative status of the base grid on a displaying screen.

In an embodiment, each of the plurality of base grids has a predefined size.

In an embodiment, the displaying screen is a map application.

In an embodiment, the set of RF parameters includes a reference signal received power (RSRP), a signal to noise interference ratio (SINR), a reference signal received quality (RSRQ), and a throughput.

In an embodiment, the plurality of user equipments includes an indoor user equipment, and an outdoor user equipment.

In an embodiment, for the IMSI level-based grouping, the processing unit is configured to extract an international mobile subscriber identity (IMSI) from the plurality of data samples associated with each of the user equipment, group the plurality of data samples based on the extracted IMSI of each user equipment on a predefined frequency to generate an IMSI wise data, aggregate the IMSI wise data corresponding to each RF parameter of the set of RF parameters to determine the plurality of KPIs for the extracted IMSI, and plot the determined plurality of KPIs for the extracted IMSI on the map application.

In an embodiment, the server is configured to store the plurality of received data samples for a predefined time along with a time stamp.

In an embodiment, the operative status is a congested status or a non-congested status.

The present disclosure discloses a method of determining an operative status of a base grid for network analysis. The method includes storing, in a server, a plurality of data samples received from a plurality of user equipments residing in a geographic area defined by a plurality of base grids. The method includes grouping, by a processing unit, the plurality of data samples into one or more groups based on at least one of an international mobile subscriber identity (IMSI) level or a map level. The method includes aggregating the plurality of grouped data samples of each group corresponding to each radio-frequency (RF) parameter of a set of RF parameters to determine a plurality of key performance indicators (KPIs) corresponding to each base grid. The method includes displaying the generated plurality of KPIs representing the operative status of the base grid on a displaying screen.

In an embodiment, for the IMSI level-based grouping the method further comprising following steps extracting an international mobile subscriber identity (IMSI) from the plurality of data samples associated with each of the user equipment. The method includes grouping the plurality of data samples based on the extracted IMSI of each user equipment on a predefined frequency to generate an IMSI wise data. The method includes aggregating the IMSI wise data corresponding to each radio-frequency (RF) parameter of the set of RF parameters to determine the plurality of key performance indicators (KPIs) for the extracted IMSI. The method includes plotting the determined plurality of KPIs for the extracted IMSI on the map application.

In an embodiment, the method further comprising storing the plurality of received data samples for a predefined time along with a time stamp.

In an embodiment, the operative status is a congested status, or a non-congested status.

In an embodiment, the method further comprising aggregating data on the IMSI level to provide a real time health state of each IMSI within the base grid.

In an embodiment, the method further comprising summarizing data on different levels, thereby reducing the number of data points to be processed and displayed, resulting in improvement in performance and scalability.

In an embodiment, the health state includes an active state, an inactive state, a barred state, and a roaming state.

In an embodiment, the method further comprising identifying a real time issue with a specific user based on each IMSI based on the determined plurality of KPIs.

In an embodiment, the real time issue includes a service provisioning issue, a roaming related issue, a network congestion, and an authentication failure issue.

The present disclosure discloses a user equipment (UE) configured to determine an operative status of at least one base grid for network analysis. The user equipment includes a processing unit, and a computer readable storage medium storing programming instructions for execution by the processing unit. Under the instructions, the processing unit is configured to store a plurality of data samples received from a plurality of user equipments residing in a geographic area defined by a plurality of base grids. Under the instructions, the processing unit is configured to group the plurality of data samples into one or more groups based on at least one of an international mobile subscriber identity (IMSI) level or a map level. Under the instructions, the processing unit is configured to aggregate the plurality of grouped data samples of each group corresponding to each radio-frequency (RF) parameter of a set of RF parameters to determine a plurality of key performance indicators (KPIs) corresponding to a base grid. Under the instructions, the processing unit is configured to display the generated plurality of KPIs representing an operative status of the base grid on a displaying screen.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture for implementing a system for determining an operative status of a base grid for network analysis, in accordance with an embodiment of the present disclosure.

FIG. 2 illustrates an example block diagram of the system, in accordance with an embodiment of the present disclosure.

FIG. 3 illustrates an example flow diagram illustrating steps performed by the system, in accordance with an embodiment of the present disclosure.

FIG. 4 illustrates an example representation of a map-based KPI visualization for a reference signal received power (RSRP) layer, in accordance with an embodiment of the present disclosure.

FIG. 5 illustrates an example representation of an international mobile subscriber identity (IMSI) based RSRP layer, in accordance with an embodiment of the present disclosure.

FIG. 6 illustrates an exemplary computer system in which or with which the system may be implemented, in accordance with an embodiment of the present disclosure.

FIG. 7 illustrates an example flow diagram illustrating steps of a method of determining an operative status of a base grid for network analysis, in accordance with an embodiment of the present disclosure.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—User Equipments
108—System
202—Server
204—Processing unit
206—Memory
208—A Plurality of Interfaces
210—Database
212—Data Parameter Engine
610—External Storage Device
620—Bus
630—Main Memory
640—Read Only Memory
650—Mass Storage Device
660—Communication Port
670—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

At present, when planning a wireless network, there are several coverage challenges that need to be considered. To plan a wireless network, a lot of considerations and methods such as site survey, user requirements, capacity planning, frequency planning are performed and considered. To date, in a wireless communication system, a mobile station has been performing communication with a base station that forms a cell in which the mobile station exists. The mobile station changes a base station to another base station while moving in accordance with the position thereof. However, at the time of design and displacement of a base station, depending on transmission power and direction of an antenna, there may arise an area (hereinafter referred to as a “coverage hole”) in which communication quality of any base station does not reach a value that is allowed to communicate with the mobile station. In order to detect a coverage hole or to provide a continuous network coverage, a designer of a base station divides an area into a plurality of grids (sub-areas) and sets up one evaluation point in each of these grids. Next, the designer measures communication qualities of neighbouring base stations at each of the evaluation points. Multiple iterations are required with varying inputs to arrive at the best wireless network. This traditional approach is manual, tedious, and poses several challenges. The general base grids show the network capabilities but fail to address the issues faced by each individual in a particular grid. Hence, a system and a method are required to address the aforementioned issue.

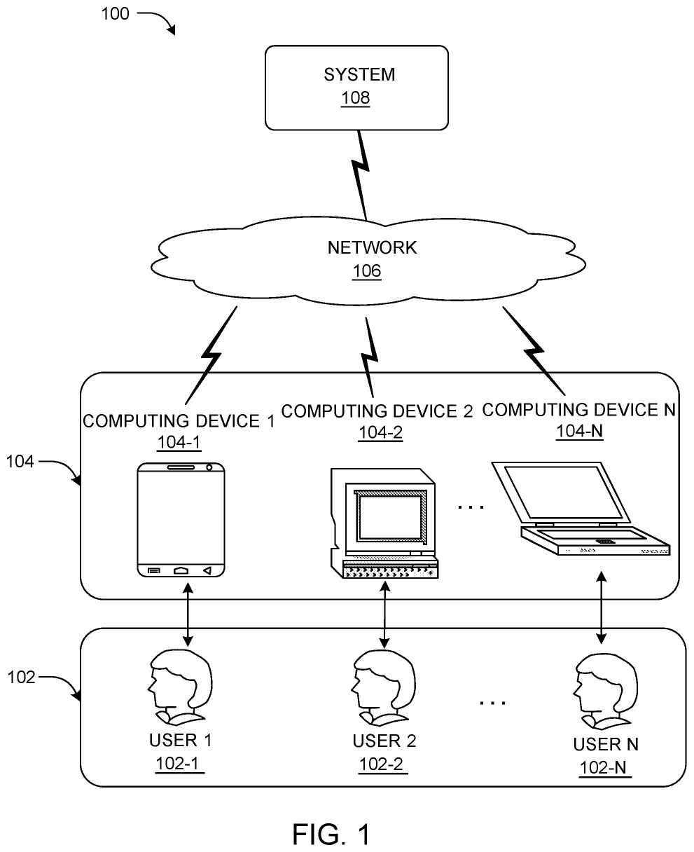

The various embodiments throughout the disclosure will be explained in more detail with reference to FIG. 1-FIG. 7.

FIG. 1 illustrates an example network architecture (100) for implementing a system (referred as “system 108”) for determining an operative status of a base grid for network analysis, in accordance with an embodiment of the present disclosure. In an example, the operative status is a congested status, or a non-congested status. In the context of a network, “congested status” typically refers to a situation where there is an unusually high volume of traffic or demand on the network resources, leading to degraded performance or service disruptions. Conversely, a “non-congested status” implies that the network is operating within normal parameters without significant traffic or capacity issues. The operative status can be either congested or non-congested, depending on the current condition of the network or system. If the network is experiencing congestion, the operative status may be classified as congested. If there are no congestion issues and the network is operating smoothly, the operative status would be considered non-congested.

In an aspect, the congested state occurs during peak hours, when there is a surge in call volume, a common occurrence during morning and evening commutes or lunch breaks. This influx of calls strains network infrastructure like base stations and switches, leading to congestion. Consequently, users may endure call drops and degraded call quality, including static or echoes. Moreover, data services suffer, with users experiencing slower speeds or difficulties accessing online content. In densely populated areas, events such as concerts or emergencies like natural disasters exacerbate congestion, overwhelming the network with concentrated demand. The network's struggle to handle this surge impacts users, making placing calls, sending messages, or accessing vital information challenging.

In another aspect, the non-congested state occurs during off-peak hours, typically late at night or early morning. In the non-congested state, the network experiences a substantial reduction in traffic compared to peak times. With fewer users active on the network, ample capacity exists within the infrastructure to accommodate the decreased demand. Consequently, users enjoy optimal call quality and data speeds during these periods, experiencing minimal risk of congestion-related issues like call drops or slow internet speeds. Similarly, in rural or less densely populated areas, mobile networks benefit from fewer subscribers compared to urban centres.

As illustrated in FIG. 1, one or more computing devices (104-1, 104-2 . . . 104-N) may be connected to the system through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) is configured to receive a plurality of data samples from the plurality of user equipments residing in a residing in a geographic area. The geographic area is defined by a plurality of base grids. In an aspect, each of the plurality of base grids has a predefined size (area). In an aspect, the predefined size may be a 500 m² area. The predefined size is configurable and may vary depending on the requirements of the network providers. In 5G networks, the base grid is the arrangement of cell sites or base stations that provide coverage and facilitate communication between multiple user equipments and the network. The size of the base grid can vary depending on factors such as population density, terrain, and network capacity requirements. In areas with high population density and heavy network usage, such as urban areas, the base grid might have smaller cell sizes to accommodate the high demand for data and connectivity. The predefined size of the base grid in 5G networks can vary based on the deployment strategy of the network operator and the requirements of the specific area being covered. The plurality of data samples (geo located data) may include details such as network traffic patterns, international mobile subscriber identity (IMSI), packet headers, throughput rates, latency measurements, error rates, device configurations, routing tables, reference signal received power (RSRP), a signal to noise interference ratio (SINR), a reference signal received quality (RSRQ), a throughput, Quality of Service (QOS) parameters, throughput, a latitude, a longitude, network topology maps, security logs, and performance metrics like upload speed and download speed. Analyzing these data samples, the system enables network administrators and engineers to identify bottlenecks, security threats, and performance issues and optimize network efficiency and reliability. The system (108) is configured to group the plurality of data samples into one or more groups based on at least one of an international mobile subscriber identity (IMSI) level and a map level. After grouping the plurality of data samples, the system (108) is configured to aggregate the plurality of grouped data samples of each group corresponding to each radio-frequency (RF) parameter of a set of RF parameters to determine a plurality of key performance indicators (KPIs) corresponding to each base grid. In an aspect, the system (108) is configured to aggregate the received plurality of data samples to generate a plurality of points such that at least one polygons representing a base grid can be generated. In an example, the plurality of user equipments is an indoor user equipment, and an outdoor user equipments. In an embodiment, the set of RF parameters includes reference signal received power (RSRP), reference signal received quality (RSRQ), received signal strength indicator (RSSI), signal to interference noise ratio (SINR), throughput, channel quality index (CQI), physical cell identity (PCI), block error ratio (BLER), downlink throughput, and uplink throughput.

In an aspect, based on the received plurality of data samples, the system is configured to define an area of each base grid. The system is configured to group and aggregate data received from the plurality of user equipments into one or more groups based on at least one of an international mobile subscriber identity (IMSI) level and a map level. In an example, the system is configured to divide the data into two groups further including a first group having RF attributes (having RSRP, RSRQ, and SINR) and a second group having non-RF attributes (throughput, latitude, and longitude).

Further, the system is configured to process the aggregated data to generate the plurality of base grids including a plurality of key performance indicators (KPIs) (also known as a plurality of key metrics). The plurality of key metrics shows performance at different levels of granularity. The system is configured to display the generated key metrics on a displaying screen. In an aspect, the displaying screen is a map application.

In an embodiment, the system (108) extracts an IMSI based data and a map-based data. Further, the system (108) receives the predefined grid size based on a geographical area.

In an operative aspect, in the IMSI level-based aggregation includes the data is aggregated IMSI wise for all RF attributes for each base grid on a predefined frequency. Further, the aggregated data is plotted IMSI wise on a map application.

In an embodiment, the IMSI data (data is aggregated IMSI wise) include but not limited to RSRP, SINR, RSRQ, a throughput, a Latitude, and a Longitude.

In an embodiment, the system (108) aggregates the IMSI based data for at least one RF parameter associated with the predefined grid for a predefined period. In an embodiment, the system (108) visualizes the IMSI based data to identify quality and coverage issues associated with the geographical location of the predefined grid. In an embodiment, the system (108) visualizes the IMSI based data to determine a user experience associated with the one or more users (102) during real-time.

In an embodiment, the system (108) is configured to employ base data aggregation grouping. Data can be categorized and summarized using base data aggregation grouping, which enables users to quickly comprehend important metrics and analyze performance at varying levels of detail. Additionally, by utilizing IMSI level identification and plotting, it is possible to identify real-time issues with specific users, even if the network is functioning properly but the user is facing multiple difficulties.

In an operative aspect, in the map level-based aggregation, the data is aggregated for all RF attributes (RSRP, RSRQ, SINR) for each grid on the predefined frequency. Further, the RF attributes aggregated data is plotted to identify an area based on coverage and quality. In an example, the predefined frequency is daily and a weekly level.

In an aspect, the system (108) provides an accurate coverage analysis by overlaying a network coverage data with geographic features such as terrain, buildings, and vegetation. The system (108) identifies coverage gaps, dead zones, and areas with weak signal strength, enabling network planners to optimize coverage and improve service quality.

In an embodiment, the system (108) is configured to determine network capacity requirements by analyzing population density, traffic patterns, and user demand at different geographic locations. The system (108) allows network planners to identify high-traffic areas and allocate network resources effectively to ensure optimal performance and avoid congestion.

In an embodiment, the system (108) is configured to assist in site selection for network infrastructure deployment, such as cell towers or base stations. The system (108) considers factors like population density, land use, road networks, and existing infrastructure to identify suitable locations that maximize coverage, minimize interference, and comply with regulatory requirements.

In an embodiment, the system (108) is configured to generate an optimizing network performance by analyzing network parameters like signal strength, signal interference, and handover patterns in different geographic areas. The system (108) is configured to identify areas with suboptimal performance, enabling network engineers to adjust and fine-tune network configurations for improved service quality.

In an embodiment, the system (108) is configured to generate strategic network expansion planning by identifying underserved or unserved areas where network coverage can be extended to reach a larger customer base. The system (108) is configured to utilize demographic data, population trends, and market demand to guide network expansion strategies.

In an embodiment, the system (108) is configured to generate real-time network monitoring by integrating network performance data with geographic information. The system (108) is configured to visualize network metrics on maps, identify areas experiencing service disruptions, and facilitate proactive troubleshooting and maintenance.

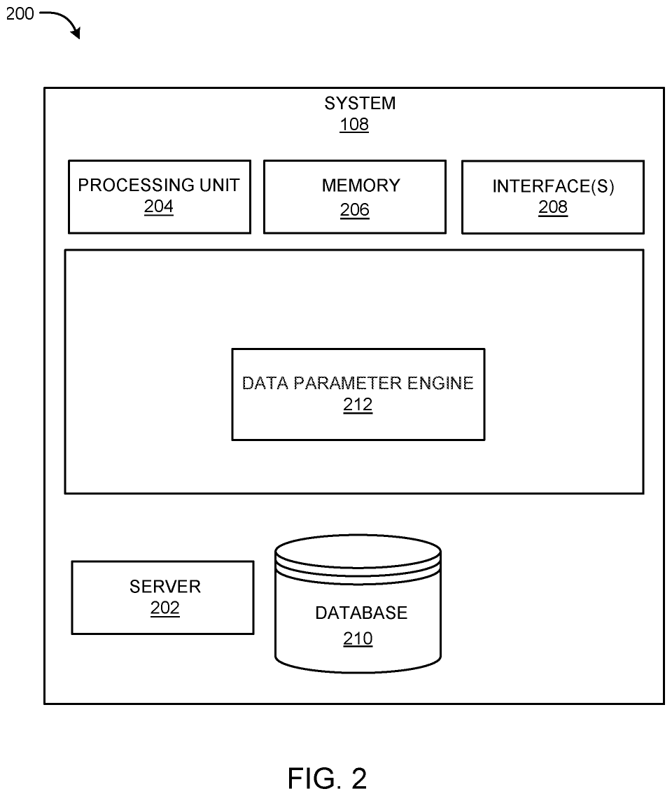

FIG. 2 illustrates an example block diagram (200) of the system (108), in accordance with an embodiment of the present disclosure.

Referring to FIG. 2, in an embodiment, the system (108) includes a server (202) and a processing unit (204).

The server (202) is configured to receive the plurality of data samples from the plurality of user equipments residing in a geographic area. The geographic area is defined by the plurality of base grids. In an example, each of the plurality of base grids has a predefined size. In an embodiment, the plurality of user equipments includes an indoor user equipment, and an outdoor user equipment. In an aspect, the server (202) is configured to store the received plurality of data samples in a database. In an aspect, the server (202) is configured to store the plurality of data samples for a predefined time along with a time stamp. In an example, the predefined time may lie in a range of 7-15 days.

The processing unit (204) is configured to cooperate with the server (202) to receive the plurality of data samples. The processing unit (204) is further configured to group the plurality of data samples into one or more groups. The processing unit (204) is configured to group the plurality of data samples based on an international mobile subscriber identity (IMSI) level, on a map level or a combination thereof. The processing unit (204) is configured to aggregate the plurality of grouped data samples of each group corresponding to each RF parameter of a set of RF parameters. In an aspect, the set of RF parameters includes a reference signal received power (RSRP), a signal to noise interference ratio (SINR), a reference signal received quality (RSRQ), and a throughput. The processing unit (204) is configured to aggregate the plurality of grouped data samples corresponding to each RF parameter for determining the plurality of KPIs corresponding to each base grid. The plurality of KPIs represents the operative status of the base grid. The processing unit (204) is further configured to display the determined plurality of KPIs a displaying screen. For example, the displaying screen is a map application.

In an operative aspect, for the IMSI level-based grouping, the processing unit (204) is configured to extract an international mobile subscriber identity (IMSI) associated with each of the user equipment from the plurality of data samples. After extracting the IMSI associated with each of the user equipment, the processing unit (204) groups the plurality of data samples based on the extracted IMSI of each user equipment on a predefined frequency to generate an IMSI wise data. For example, for IMSI “qwe”, the processing unit (204) groups all the data which are related to the IMSI “qwe”, thereby creating a plurality of groups corresponding the plurality of groups based on the IMSI. The processing unit (204) aggregates the IMSI wise data corresponding to each RF parameter of the set of RF parameters to determine the plurality of KPIs for the extracted IMSI. For example, for calculating a value for RSRP KPI corresponding to a RSRP parameter, the processing unit (204) extracts a plurality of RSRP values from the IMSI wise data (having plurality of data samples) and is further configured to determine the value for RSRP KPI for applying at least one mathematical operation on the plurality of extracted RSRP values. In an example, the at least one mathematical operation is an average operation, a mean operation. The processing unit (204) is configured to plot the determined plurality of KPIs for the extracted IMSI on the map application.

The processing unit (204) is implemented as one or more microprocessors, microcomputers, microcontrollers, digital signal processors, central processing units, logic circuitries, and/or any devices that process data based on operational instructions. Among other capabilities, the processing unit (204) is configured to fetch and execute computer-readable instructions stored in a memory (206) of the system (108). The memory (206) is configured to store one or more computer-readable instructions or routines in a non-transitory computer readable storage medium, which is fetched and executed to create or share data packets over a network service. The memory (206) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (208). The interface(s) (208) may comprise a variety of interfaces, for example, interfaces for data input and output devices (I/O), storage devices, and the like. The interface(s) (208) may facilitate communication through the system (108). The interface(s) (208) may also provide a communication pathway for one or more components of the system (108). Examples of such components include, but are not limited to, processing unit (204) and a database (210). Further, the processing unit (204) may include a data parameter engine (212) and other engine(s). In an embodiment, the other engine(s) may include, but not limited to, a data ingestion engine, an input/output engine, and a notification engine.

In an embodiment, the processing unit (204) is implemented as a combination of hardware and programming (for example, programmable instructions) to implement one or more functionalities of the processing unit (204). In examples described herein, such combinations of hardware and programming is implemented in several different ways. For example, the programming for the processing unit (204) is processor-executable instructions stored on a non-transitory machine-readable storage medium and the hardware for the processing unit (204) may comprise a processing resource (for example, one or more processors), to execute such instructions. In the present examples, the machine-readable storage medium may store instructions that, when executed by the processing resource, implement the processing unit (204). In such examples, the system (108) may comprise the machine-readable storage medium storing the instructions and the processing resource to execute the instructions, or the machine-readable storage medium is separate but accessible to the system (108) and the processing resource. In other examples, the processing unit (204) is implemented by electronic circuitry.

In an embodiment, the processing unit (204) receives an input via the data parameter engine (212). The input is received from the one or more computing devices (104) associated with the one or more users (102). The processing unit (204) may store the input in the database (210). The input is based on a network parameters associated with the computing device (104). The data includes a plurality of aggregated RF parameters from the one or more users (102) based on the predefined grid.

In an embodiment, the processing unit (204) extracts the IMSI based data and the map-based data from the server (202).

In an embodiment, the data includes but not limited to a RSRP, a signal to noise interference ratio (SINR), a reference signal received quality (RSRQ), a throughput, a Latitude, and a Longitude.

In an embodiment, the processing unit (204) aggregates the IMSI based data for one or more RF parameters associated with the predefined grid for the predefined period.

In an embodiment, the processing unit (204) visualizes the IMSI based data to identify quality and coverage issues associated with the geographical location of the predefined grid.

In an embodiment, the processing unit (204) visualizes the IMSI based data to determine a user experience associated with the one or more users (102) during real-time.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

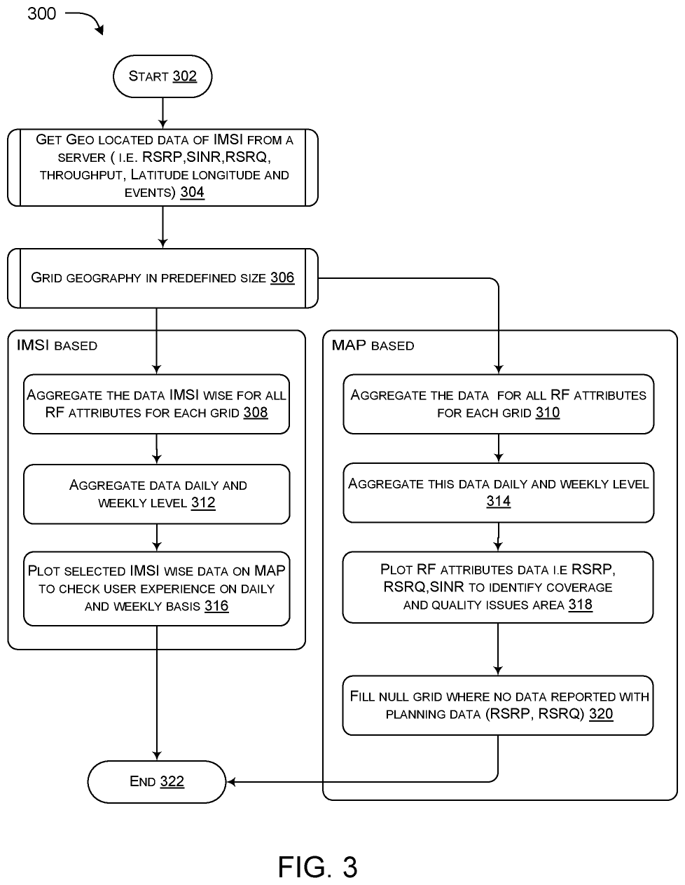

FIG. 3 illustrates an example flow diagram (300) illustrating steps performed by the system (108), in accordance with an embodiment of the present disclosure.

At step 302: The system (108) initializes a process for determining an operative status of the base grid for network analysis. In an aspect, the process includes a step of creating the plurality of base grids for degree grid implementation and grid aggregation.

At step 304: The system (108) receives the plurality of data samples (geo located data) of a particular user (based on IMSI) from the server (202) associated with the user (102). In an example, the geo located data includes RSRP, SINR, RSRQ, throughput, latitude, longitude, and events related to the user equipment.

At step 306: The system (108) determines a grid geography in a predefined size. In an example, the geographic area where the user resides is defined by the plurality of base grids. In an example, a network area may be divided into the plurality of base grids, where each base grid has a predefined size (area).

At step 308: The system (108) aggregates the data (IMSI based data) based on the IMSI for all RF parameters (RF attributes) for each base grid.

At step 310: The system (108) aggregates the map-based data for all the RF attributes of each base grid.

At step 312: The system (108) aggregates the IMSI based data on daily and a weekly level.

At step 314: The system (108) aggregates the map-based data on daily and a weekly level.

At step 316: The system (108) plots the IMSI based data on a map to check user experience on a daily and a weekly basis.

At step 318: The system (108) plots the RF attributes data (RSRP, RSRQ, SINR) based on the map-based data to identify coverage and quality issues area.

At step 320: The system (108) fills null grid (where no data reported with the planning data) associated with the map-based data.

At step 322: The system (108) terminates the process associated with the IMSI based data and the map-based data.

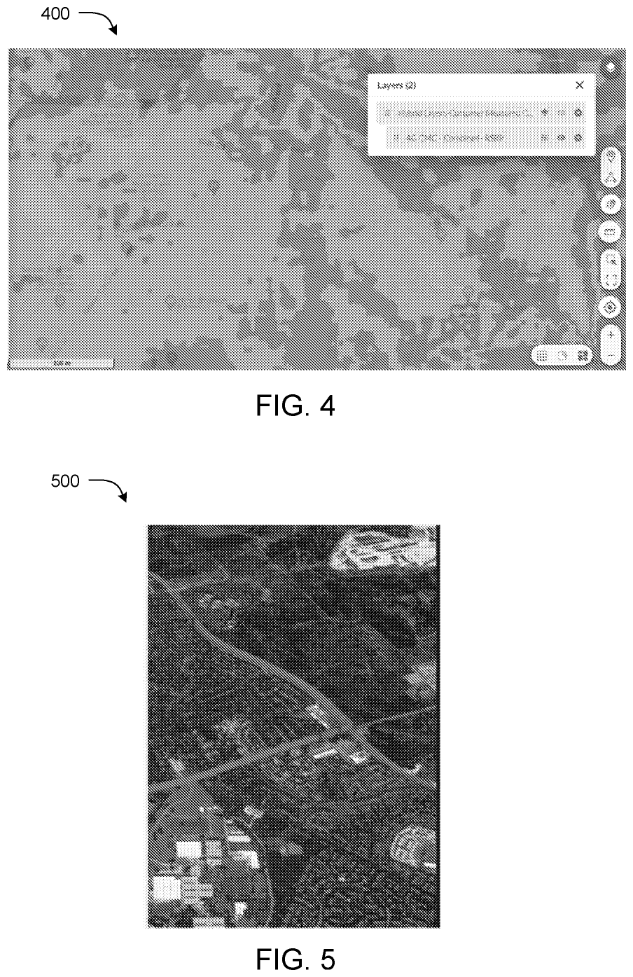

FIG. 4 illustrates an exemplary representation (400) of a map-based KPI visualization for a reference signal received power (RSRP) layer, in accordance with an embodiment of the present disclosure.

In an embodiment, the system (108) aggregates data using the IMSI based data and the map-based data. As illustrated in FIG. 4, the system (108) generates a map based on RF key performance indicators (KPIs) (RSRP, RSRQ, SINR) where the map-based KPIs is aggregated to a predefined grid size. Further, the system (108) uses the input data upon a non-availability of the data for the null grids.

FIG. 5 illustrates an exemplary representation (500) of an international mobile subscriber identity (IMSI) based RSRP layer, in accordance with an embodiment of the present disclosure.

As illustrated in FIG. 5, in an embodiment, the system (108) visualizes the IMSI based data for each predefined base grid. The data collected for each predefined grid corresponding to the user equipment based on IMSI is known as IMSI wise data. The IMSI wise data is further processed for generating RF KPIs (Key Performance Indicators) and providing valuable insights into the user experience journey. By utilizing the IMSI wise data, it is possible to plot the user experience journey on the mapping application, as demonstrated in FIG. 5. In an embodiment, the aggregation of IMSI based data provides a real time health status of each IMSI within the predefined grid. Further, the IMSI level identification and plotting by the system (108) assists in identifying a real time issue with the user (102).

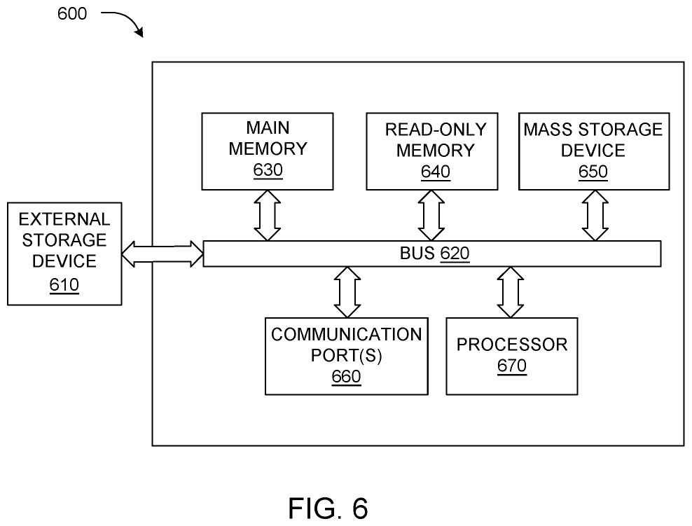

FIG. 6 illustrates an example computer system (600) in which or with which the embodiment of the present disclosure is implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) is any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) is chosen depending on a network, such as a Local Area Network (LAN), Wide Area Network (WAN), or any network to which the computer system (600) connects.

In an embodiment, the main memory (630) is Random Access Memory (RAM), or any other dynamic storage device commonly known in the art. The read-only memory (640) is any static storage device(s) e.g., but not limited to, a Programmable Read Only Memory (PROM) chip for storing static information e.g., start-up or basic input/output system (BIOS) instructions for the processor (670). The mass storage device (650) is any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) is, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (670) to the computer system (600).

In another embodiment, operator, and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

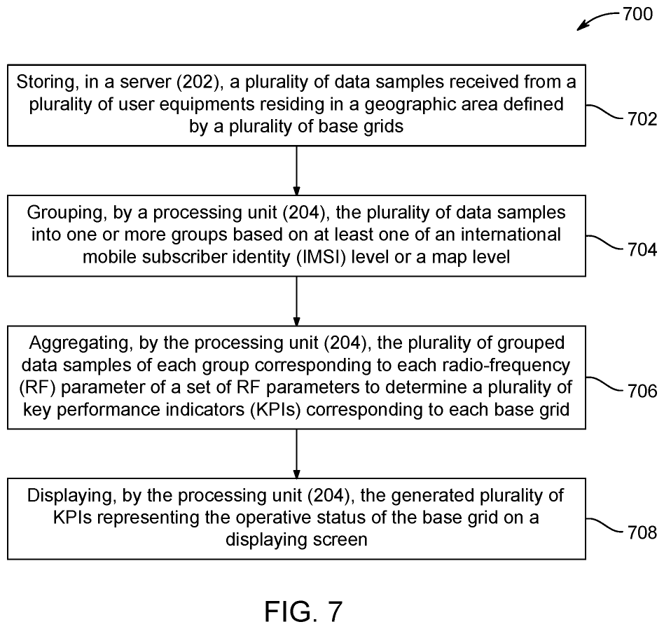

FIG. 7 illustrates an example flow diagram illustrating steps of a method (700) of determining the operative status of the base grid for network analysis, in accordance with an embodiment of the present disclosure.

At step (702), the server (202) is configured to store the plurality of data samples received from a plurality of user equipments residing in the geographic area defined by the plurality of base grids. In an example, the plurality of data samples includes various details associated with the user equipment and the environment associated with the user equipment, such as network traffic patterns, international mobile subscriber identity (IMSI), packet headers, throughput rates, latency measurements, error rates, device configurations, routing tables, RSRP, SINR, RSRQ, a throughput, QoS parameters, throughput, a latitude, a longitude, upload speed, and download speed.

At step (704), the processing unit (204) is configured to group the plurality of data samples into one or more groups based on at least one of an international mobile subscriber identity (IMSI) level or a map level.

At step (706), the processing unit (204) is configured to aggregate the plurality of grouped data samples of each group corresponding to each radio-frequency (RF) parameter of the set of RF parameters to determine the plurality of key performance indicators (KPIs) corresponding to each base grid. For the IMSI level-based grouping, the processing unit (204) is configured to extract the IMSI from the plurality of data samples associated with each of the user equipment and grouped the plurality of data samples based on the extracted IMSI of each user equipment to generate an IMSI wise data. In an example, the processing unit (204) is configured to group the data on a predefined frequency. In an example, the predefined frequency is weekly or daily. The processing unit (204) is configured to aggregate the IMSI wise data corresponding to each radio-frequency (RF) parameter to determine the plurality of key performance indicators (KPIs) for the extracted IMSI. The processing unit (204) is configured to plot the determined plurality of KPIs for the extracted IMSI on the map application.

At step (708), the processing unit (204) is configured to display the generated plurality of KPIs representing the operative status of the base grid on the displaying screen.

In an embodiment, the method (700) further comprising storing the plurality of received data samples for a predefined time along with a time stamp. In an example, the predefined time may lie in a range of 7-15 days.

In an embodiment, the method includes a step of gathering data at the International Mobile Subscriber Identity (IMSI) level to provide a real-time health status of each IMSI within the base grid. This data includes information about various network parameters such as signal strength, data usage, and call quality. By collecting this data at the IMSI level, the method can identify and isolate issues affecting individual users, enabling swift resolution of problems.

In another embodiment, the method includes a step of summarizing data at various levels to reduce the number of data points that must be processed and displayed, resulting in improved performance and scalability. This summarization process involves aggregating data from individual IMSIs to higher levels such as cell towers, clusters, or regions. By reducing the number of data points, the method improves the efficiency of data processing and visualization. In an example, the health status comprises various states such as an active state, an inactive state, a barred state, and a roaming state. The active state indicates that the user is currently using the network and has a valid subscription. The inactive state indicates that the user has not used the network for a specified period and may require reactivation. The barred state indicates that the user has been blocked from accessing the network due to billing or security issues, and the roaming state indicates that the user is currently using a network other than their home network. In another embodiment, the method includes a step of identifying a real-time issue with a specific user based on each IMSI, determined by a plurality of Key Performance Indicators (KPIs). These KPIs include various network parameters such as call drops, data throughput, and latency. By analyzing these KPIs, the method can pinpoint the root cause of network issues affecting individual users, enabling swift resolution of problems. In an example, the real-time issue may include service provisioning issues, roaming-related issues, network congestion, and authentication failures. Service provisioning issues may occur when a user does not have the correct subscription or has exhausted their data quota. Roaming-related issues may occur when a user travels and cannot access the network due to a lack of roaming agreements. Network congestion may occur when the network is unable to handle the volume of traffic, resulting in slow data speeds or dropped calls. Authentication failures may occur when the user's identity cannot be verified, preventing access to the network. By identifying these issues in real-time, the method can improve the overall reliability and performance of the network.

In an aspect, the present disclosure discloses a user equipment (UE) which is configured to determine the operative status of the base grid for network analysis. The UE includes a processing unit, and a computer readable storage medium storing programming instructions for execution by the processing unit. Under the instructions, the processing unit is configured to store the plurality of data samples received from the plurality of user equipments residing in the geographic area defined by the plurality of base grids. Under the instructions, the processing unit is configured to group the plurality of data samples into one or more groups based on at least one of an international mobile subscriber identity (IMSI) level or a map level. Under the instructions, the processing unit is configured to aggregate the plurality of grouped data samples of each group corresponding to each radio-frequency (RF) parameter of the set of RF parameters to determine a plurality of key performance indicators (KPIs) corresponding to a base grid. Under the instructions, the processing unit is configured to display the generated plurality of KPIs representing an operative status of the base grid on a displaying screen of the UE.

The present disclosure is configured to provide wireless network planning and design of 5G networks. The system (108) can be extended to other technologies as well such as Wi-Fi, and various areas where base grids are required. The system (108) is helpful for telecom operators to assess and improve network coverage and quality of service. It could aid in identifying areas with poor coverage, both indoors and outdoors, and help plan for network optimization.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### Advantages of the Invention

The present disclosure provides a system and a method that provides valuable insights about a base grid regarding geographic distribution of network usage, allowing for more accurate network planning and optimization.

The present disclosure provides a system and a method where a base grid identifies areas with poor signal strength, coverage gaps, or high interference thereby improving service quality, optimizing signal propagation, and reducing dropped calls or data loss.

The present disclosure provides a system and a method that assists in selecting optimal sites for network infrastructure deployment, such as towers, base stations, or small cells. The system considers factors like population density, terrain, and existing infrastructure, operators may strategically position network assets to maximize coverage, minimize signal interference, and optimize network capacity.

The present disclosure provides a system and a method where a base grid enables operators to gain insights into the spatial distribution of their customer base. This information can be used for targeted marketing campaigns, personalized offers, and location-based services leading to customer satisfaction.

The present disclosure provides a system and a method where a base grid provides real-time monitoring of network performance by integrating geospatial data with network performance metrics and identifies areas experiencing service degradation or congestion and prioritizes troubleshooting efforts.

The present disclosure provides a system and a method where a base grid helps optimize the allocation of network resources, such as spectrum, bandwidth, and capacity. By understanding the spatial distribution of network demands, operators may allocate resources based on actual usage patterns, resulting in more efficient resource utilization, improved network efficiency, and cost savings.

The present disclosure provides a system and a method where a base grid provides operators with a competitive edge by enabling them to understand their network coverage and performance in comparison to competitors. By identifying areas of competitive advantage or weakness, operators can strategically invest in network expansion, service enhancements, or targeted marketing to gain market share and retain customers.

The present disclosure provides a system and a method where a base grid allows for the consolidation and summarization of large volumes of data into a structured format. The system simplifies data analysis process by providing a concise overview of key metrics and trends at different levels of aggregation.

The present disclosure provides a system and a method where a base grid provides a clear and organized representation of complex information and promotes better data interpretation and facilitates decision-making based on the summarized information.

The present disclosure provides a system and a method where a hierarchical structure of an aggregated grouping of the base grid enables efficient data navigation and exploration.

The present disclosure provides a system and a method where the aggregated grouping of the base grid summarizes data at different levels of aggregation, reduces the number of data points to be processed and displayed. This improves performance and scalability, allowing users to analyze and visualize large volumes of data efficiently.

The present disclosure provides a system and a method where the aggregated grouping of the base grid offers customization options to tailor the display and analysis based on specific requirements. Further, the system provides flexibility to users to focus on relevant aspects of the data and adapt the base grid to suit their analysis needs.

The present disclosure provides a system and a method where aggregated grouping of the base grid provides a visually appealing and concise representation of data, making it suitable for communication and presentation purposes. Hence, the users may generate reports, dashboards, or visualizations based on the aggregated base grid, facilitating data-driven communication to stakeholders.

We claim:

1. A system (108) for determining an operative status of a base grid for network analysis, the system (108) comprising:
a server (202) configured to store a plurality of data samples received from a plurality of user equipments residing in a geographic area defined by a plurality of base grids; and
a processing unit (204) configured to cooperate with the server to receive the plurality of data samples and is further configured to:
group the plurality of data samples into one or more groups based on at least one of an international mobile subscriber identity (IMSI) level and a map level;
aggregate the plurality of grouped data samples of each group corresponding to each radio-frequency (RF) parameter of a set of RF parameters to determine a plurality of key performance indicators (KPIs) corresponding to each base grid; and
display the determined plurality of KPIs representing the operative status of the base grid on a displaying screen.

2. The system (108) as claimed in claim 1, wherein each of the plurality of base grids has a predefined size.

3. The system (108) as claimed in claim 1, wherein the displaying screen is a map application.

4. The system (108) as claimed in claim 1, wherein the set of RF parameters includes a reference signal received power (RSRP), a signal to noise interference ratio (SINR), a reference signal received quality (RSRQ), and a throughput.

5. The system (108) as claimed in claim 1, wherein the plurality of user equipments includes an indoor user equipment, and an outdoor user equipment.

6. The system (108) as claimed in claim 1, wherein for the IMSI level-based grouping, the processing unit (204) is configured to:
extract an international mobile subscriber identity (IMSI) associated with each of the user equipment from the plurality of data samples;
group the plurality of data samples based on the extracted IMSI of each user equipment on a predefined frequency to generate an IMSI wise data;
aggregate the IMSI wise data corresponding to each RF parameter of the set of RF parameters to determine the plurality of KPIs for the extracted IMSI; and
plot the determined plurality of KPIs for the extracted IMSI on the map application.

7. The system (108) as claimed in claim 1, wherein the server (202) is configured to store the plurality of received data samples for a predefined time along with a time stamp.

8. The system (108) as claimed in claim 1, wherein the operative status is a congested status, or a non-congested status.

9. A method (700) of determining an operative status of a base grid for network analysis, the method comprising:
storing (702), in a server, a plurality of data samples received from a plurality of user equipments residing in a geographic area defined by a plurality of base grids;
grouping (704), by a processing unit (204), the plurality of data samples into one or more groups based on at least one of an international mobile subscriber identity (IMSI) level or a map level;
aggregating (704), by the processing unit (204), the plurality of grouped data samples of each group corresponding to each radio-frequency (RF) parameter of a set of RF parameters to determine a plurality of key performance indicators (KPIs) corresponding to each base grid; and
displaying (706), by the processing unit (204), the generated plurality of KPIs representing the operative status of the base grid on a displaying screen.

10. The method (700) as claimed in claim 9, further comprising following steps for the IMSI level-based grouping:
extracting an international mobile subscriber identity (IMSI) associated with each of the user equipment from the plurality of data samples;
grouping the plurality of data samples based on the extracted IMSI of each user equipment on a predefined frequency to generate an IMSI wise data;
aggregating the IMSI wise data corresponding to each radio-frequency (RF) parameter of the set of RF parameters to determine the plurality of key performance indicators (KPIs) for the extracted IMSI; and
plotting the determined plurality of KPIs for the extracted IMSI on the map application.

11. The method (700) as claimed in claim 9, further comprising storing the plurality of received data samples for a predefined time along with a time stamp.

12. The method (700) as claimed in claim 9, wherein the operative status is a congested status, or a non-congested status.

13. The method (700), as claimed in claim 10, further comprising aggregating data on the IMSI level to provide a real-time health state of each IMSI within the base grid.

14. The method (700) as claimed in claim 10, further comprising summarizing data on different levels, thereby reducing the number of data points to be processed and displayed, resulting in improvement in performance and scalability.

15. The method (700) as claimed in claim 13, wherein the health state includes an active state, an inactive state, a barred state, and a roaming state.

16. The method (700), as claimed in claim 10, further comprising identifying a real-time issue with a specific user based on each IMSI based on the determined plurality of KPIs.

17. The method (700) as claimed in claim 16, wherein the real-time issue includes a service provisioning issue, a roaming-related issue, network congestion, and an authentication failure issue.

18. A user equipment (UE) configured to determine an operative status of a base grid for network analysis, the UE comprising:
a processing unit; and
a computer readable storage medium storing programming instructions for execution by the processing unit, the programming including instructions to:
store a plurality of data samples received from a plurality of user equipments residing in a geographic area defined by a plurality of base grids;
group the plurality of data samples into one or more groups based on at least one of an international mobile subscriber identity (IMSI) level or a map level;
aggregate the plurality of grouped data samples of each group corresponding to each radio-frequency (RF) parameter of a set of RF parameters to determine a plurality of key performance indicators (KPIs) corresponding to a base grid; and
display the generated plurality of KPIs representing an operative status of the base grid on a displaying screen.

19. A computer program product comprising a non-transitory computer-readable medium comprising instructions that, when executed by one or more processors, cause the one or more processors to:
store a plurality of data samples received from a plurality of user equipments residing in a geographic area defined by a plurality of base grids;
group the plurality of data samples into one or more groups based on at least one of an international mobile subscriber identity (IMSI) level or a map level;
aggregate the plurality of grouped data samples of each group corresponding to each radio-frequency (RF) parameter of a set of RF parameters to determine a plurality of key performance indicators (KPIs) corresponding to a base grid; and
display the generated plurality of KPIs representing an operative status of the base grid on a displaying screen.
